(19) United States
(12) Patent Application Publication
(10) Pub. No.: US 2012/0086792 A1
(43) Pub. Date: Apr. 12, 2012

(54) IMAGE IDENTIFICATION AND SHARING ON MOBILE DEVICES

(75) Inventors: Amir Akbarzadeh, Bellevue, WA (US); Simon J. Baker, Los Altos Hills, CA (US); David Per Zachris Nister, Bellevue, WA (US); Scott Fynn, Seattle, WA (US)

(73) Assignee: Microsoft Corporation, Redmond, WA (US)

(21) Appl. No.: 12/901,575

(22) Filed: Oct. 11, 2010

(51) Int. Cl. H04N 7/18; G06K 9/00

(52) U.S. Cl. 348/77; 382/115; 348/E07.085

(57) ABSTRACT

Captured images are analyzed to identify portrayed individuals and/or scene elements therein. Upon user confirmation of one or more identified individuals and/or scene elements entity information is accessed to determine whether there are any available communication addresses, e.g., email addresses, SMS-based addresses, websites, etc., that correspond with or are otherwise linked to an identified individual or scene element in the current captured image. A current captured image can then be automatically transmitted, with no need for any other user effort, to those addresses located for an identified individual or scene element.

### BACKGROUND

Mobile devices, e.g., cell phones, today have increasingly sophisticated and enhanced cameras that support users capturing photographic images and video, collectively referred to herein as images. Moreover, cameras most likely will have the capability to communicate with the internet, or world wide web (www), rendering them mobile devices in their own right. Mobile devices and cameras today also have increasingly high-performance computational powers, i.e., are computer devices with significant computational power that can be applied for performing or assisting in the processing of various applications.

Users of mobile devices with camera capabilities, referred to herein as mobile camera devices, utilize their mobile camera devices to capture and store images. These users, also referred to herein as photographers, often then desire to share one or more of their captured images with one or more other people, a website or web location and/or other user devices, e.g., the photographer's home-based computer, etc.

Generally, however, with existing technology it is cumbersome and time consuming for a photographer to transfer, or otherwise download, their captured images to their desktop computer and review the captured images on the desktop computer to identify which images they desire to forward to other users, devices and/or websites. Only then can the photographer draft the appropriate send messages, e.g., emails, select the intended recipients, and finally forward the proper individual images to the desired recipients or other locations and/or interact with a website or web location to upload individual images thereto.

Thus, it is desirable to utilize the computational and communicative power of a user's mobile camera device to assist a user to efficiently identify recipients for a captured image and quickly, with minimal user effort, share the captured image with the identified recipients.

### SUMMARY

This summary is provided to introduce a selection of concepts in a simplified form which are further described below in the Detailed Description. This summary is not intended to identify key or essential features of the claimed subject matter, nor is it intended to be used as an aid in determining the scope of the claimed subject matter.

Embodiments discussed herein include systems and methodology for processing captured images and automatically transmitting captured images to one or more addresses for one or more communication networks, e.g., the internet, one or more SMS-based networks, one or more telephone system networks, etc.

In embodiments a captured image is automatically processed to attempt to identify persons portrayed therein. In embodiments best guess identifications of individuals in a captured image are output to a user for confirmation. In embodiments, when a user confirms a best guess identification of a portrayed individual in a current captured image one or more databases are searched for one or more communication network addresses for sending communications to, such as, but not limited to, emails and text messages, e.g., internet-based addresses, SMS (short message service) text messaging addresses, etc., collectively referred to herein as com addresses, associated with the confirmed portrayed individual. In embodiments if one or more associated com addresses are located, or otherwise identified, the captured image is automatically transmitted to the located com addresses.

In embodiments a captured image is also automatically processed to attempt to identify scene elements portrayed therein, such as the location of the captured image, depicted landmarks and/or other objects or entities within the captured image, e.g., buildings, family pet, etc. In embodiments best guess scene determinators that identify one or more portrayed scene elements are generated and output to a user for confirmation. In embodiments, when a user confirms a best guess scene determinator one or more databases are searched for one or more rules associating one or more com addresses with the confirmed scene element, and if located, the captured image is automatically transmitted to the located com addresses.

In embodiments user input can be utilized to identify one or more individuals and/or scene elements portrayed in a captured image. In embodiments the user input is searched on for any associated com addresses, that if located, the captured image is automatically transmitted to.

### BRIEF DESCRIPTION OF THE DRAWINGS

These and other features will now be described with reference to the drawings of certain embodiments and examples which are intended to illustrate and not to limit, and in which:

FIGS. 1A-1D illustrate an embodiment logic flow for identifying recipients of captured images and sharing the captured images with the identified recipients.

FIG. 2 depicts an exemplary captured image being processed by an embodiment image sharing system with the capability to identify recipients of captured images and share the captured images with the identified recipients.

FIG. 3 depicts an embodiment mobile device image sharing application, also referred to herein as an image share app.

FIG. 4 depicts an embodiment mobile camera device with the capability to capture images, identify recipients of the captured images and share the captured images with the identified recipients.

FIG. 5 is a block diagram of an exemplary basic computing device with the capability to process software, i.e., program code, or instructions.

### DETAILED DESCRIPTION

In the following description, for purposes of explanation, numerous specific details are set forth in order to provide a thorough understanding of embodiments described herein. It will be apparent however to one skilled in the art that the embodiments may be practiced without these specific details. In other instances well-known structures and devices are either simply referenced or shown in block diagram form in order to avoid unnecessary obscuration. Any and all titles used throughout are for ease of explanation only and are not for any limiting use.

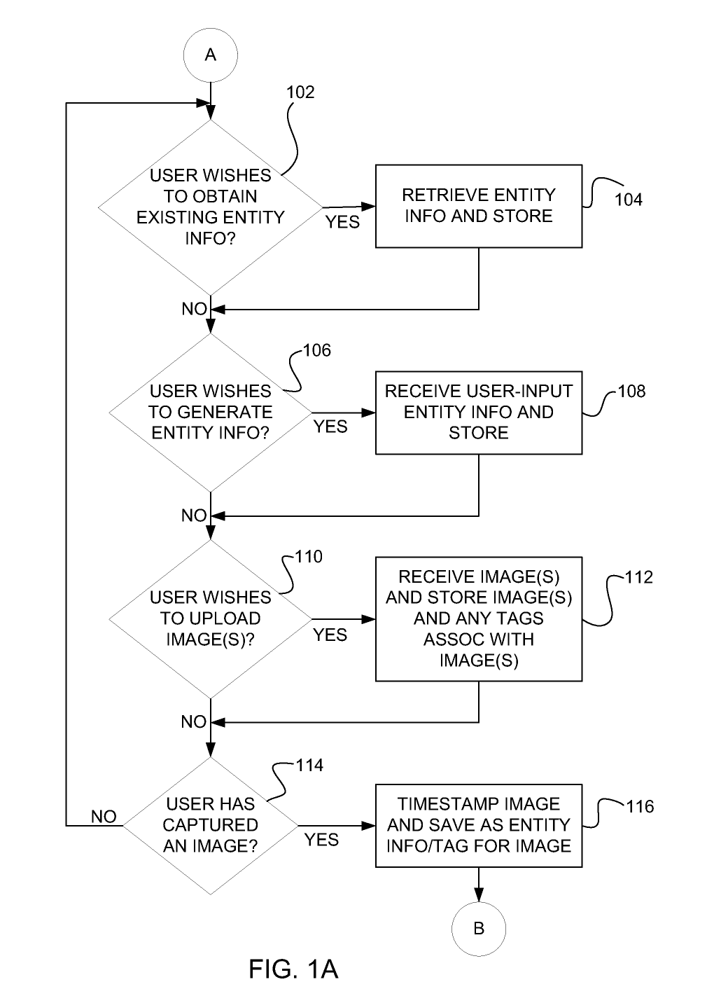

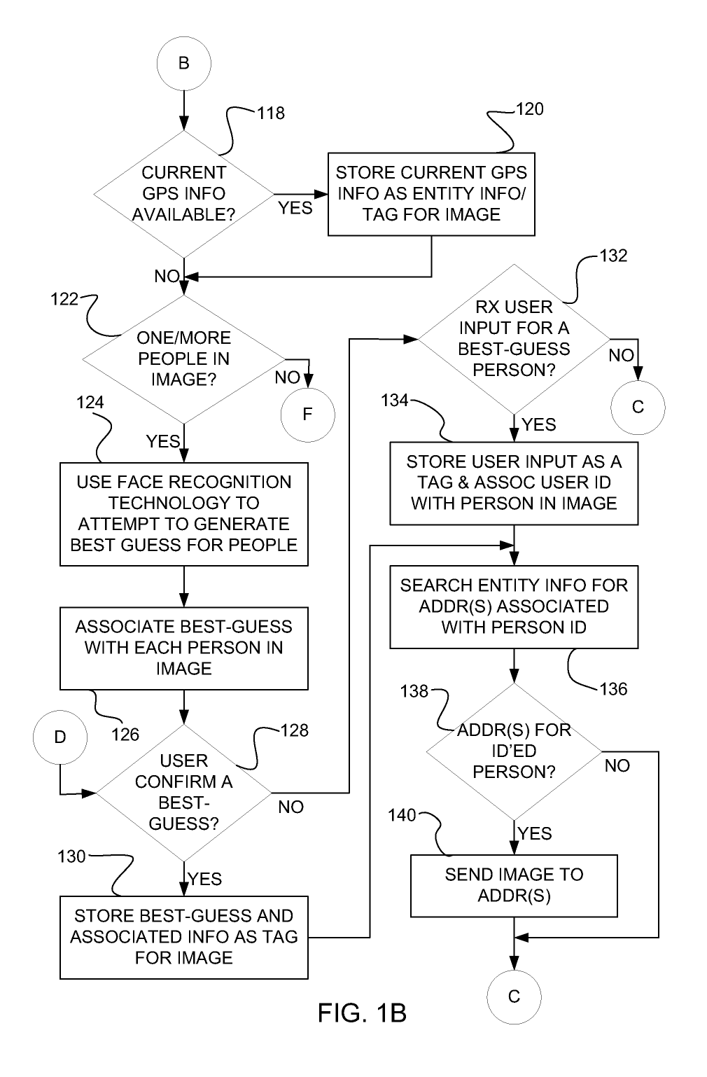

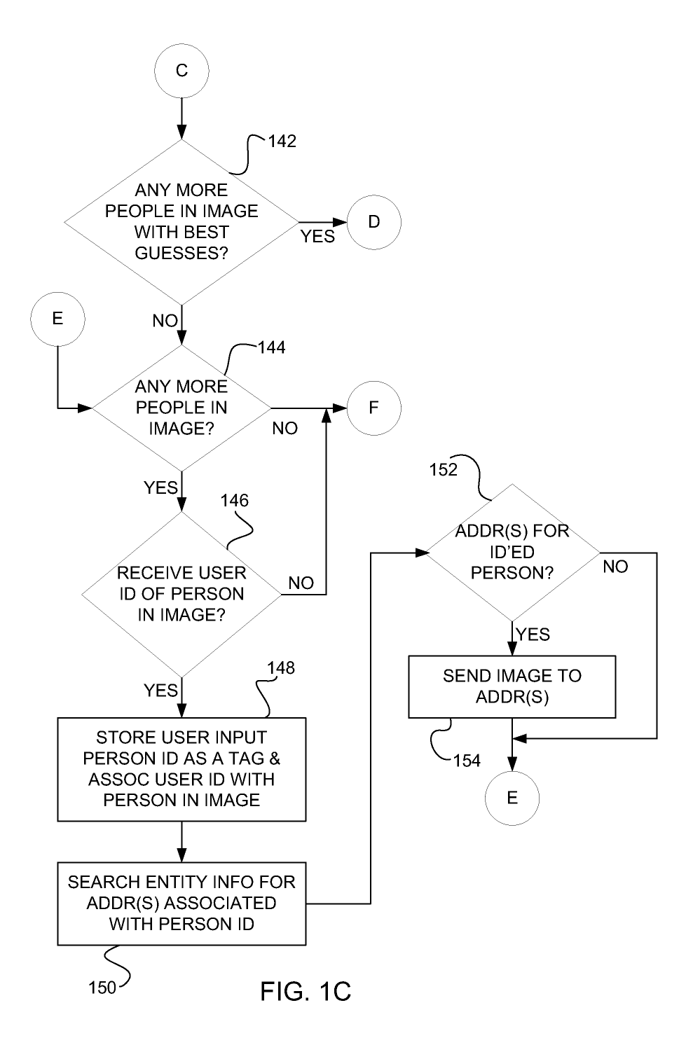

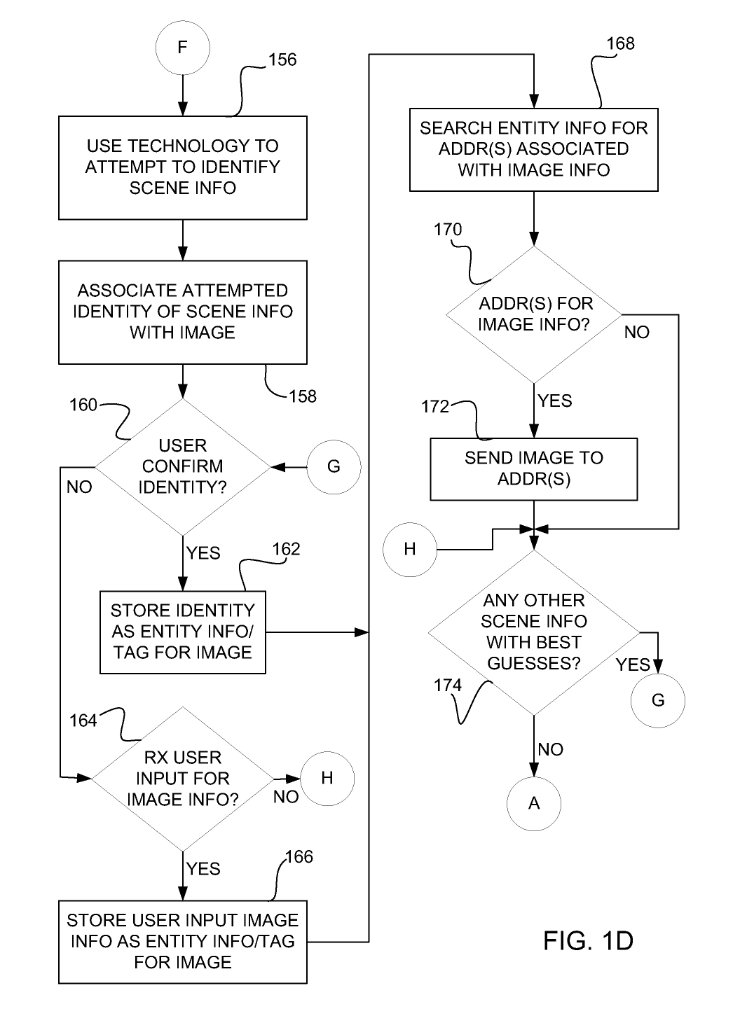

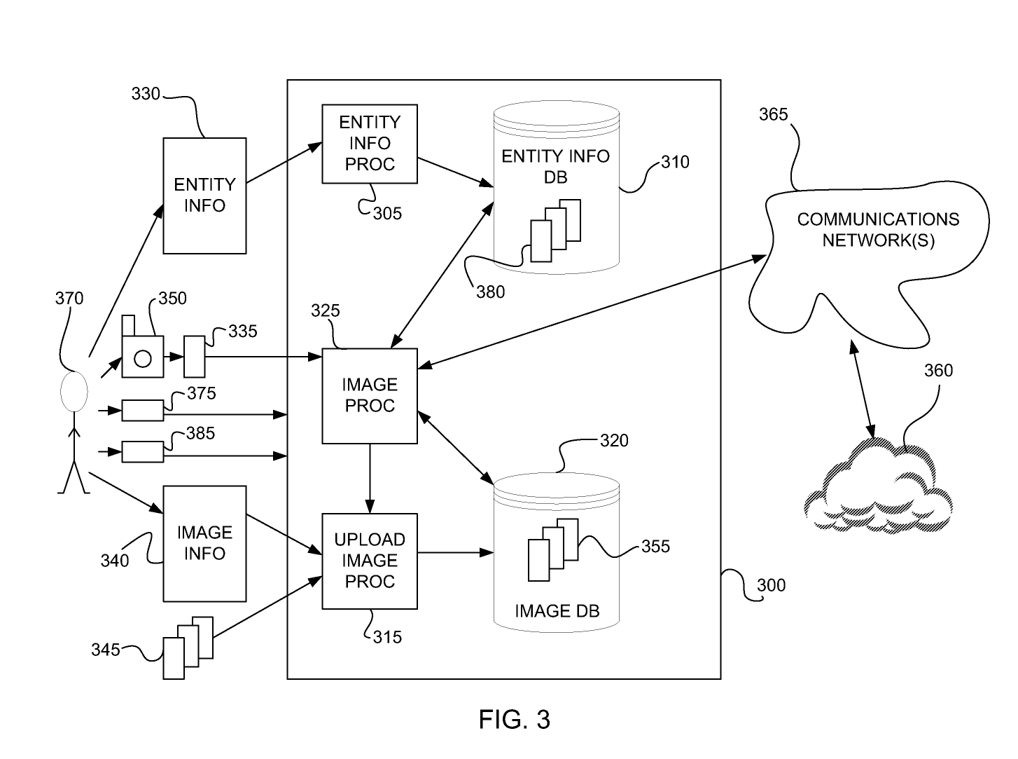

FIGS. 1A-1D illustrate an embodiment logic flow for effectively and efficiently identifying recipients of captured images and quickly sharing the captured images with the identified recipients with minimal user interaction. While the following discussion is made with respect to systems portrayed herein the operations described may be implemented in other systems. The operations described herein are not limited to the order shown. Additionally, in other alternative embodiments more or fewer operations may be performed. Further, the operations depicted may be performed by an embodiment image share app 300 depicted in FIG. 3 and further discussed below, or by an embodiment image share app 300 in combination with one or more other system entities, components and/or applications.

In an embodiment the logic flow of FIGS. 1A-1D is processed on a user's mobile camera device. In another embodiment a subset of the steps of the logic flow of FIGS. 1A-1D is processed on a user's mobile camera device and the remainder steps of the logic flow are processed on one or more other devices, mobile or otherwise. For purposes of discussion, the steps of FIGS. 1A-1D will be discussed with reference to the embodiment where the logic flow is processed on a user's mobile camera device.

In an embodiment a mobile camera device is a mobile device with computational and photographic capabilities. In an embodiment computational capabilities is the ability to execute software applications, or procedures or computer programs, i.e., execute software instructions or computer code. In an embodiment mobile devices with computational capabilities include devices with a processor for executing software applications.

In an embodiment photographic capabilities is the ability to capture images, e.g., photographs and/or videos. In an embodiment photographic capabilities also includes the ability to process captured images, e.g., utilize technology to attempt to identify individuals and/or scene elements in a captured image, generate tags for captured images, store captured images, etc.

In an embodiment mobile devices are devices that can operate as intended at a variety of locations and are not hardwired or otherwise connected to one specific location for any set time such as desk top computers. Examples of mobile camera devices include, but are not limited to, cell phones, smart phones, digital cameras, etc.

Referring to FIG. 1A in an embodiment at decision block 102 a determination is made as to whether the user wishes to obtain, or otherwise upload, existing entity information to their mobile camera device. In an embodiment existing entity information is information that identifies com addresses for sending communications to, e.g., email addresses, website or web locations, collectively referred to herein as websites, SMS text messaging addresses, etc. Email and/or website addresses are also referred to herein as internet-based addresses. An example of existing entity information is a contact list or electronic address book stored on a user's desktop computer, cell phone, etc.

In an embodiment existing entity information is one or more image share rules that identify individuals and/or com addresses for individuals for one or more individuals depicted in a captured image. Thus, for example, an image share rule can be a rule that identifies an individual John with the captured image of John such that each captured image that depicts John will be associated with John and ultimately sent to the com addresses affiliated with John in the entity information. As another example, an image share rule can be a rule that identifies an individual Alice with the captured image of Alice and also with the captured image of another individual, Bill, such that each captured image that depicts Alice and each captured image that depicts Bill will be associated with Alice and ultimate sent to the com addresses affiliated with Alice in the entity information.

In an embodiment existing entity information is also one or more image share rules that identifies individuals and/or com addresses for individuals for one or more image characteristics, or elements or components. Examples of embodiment image characteristics include, but are not limited to, image capture timeframes, image capture locations, depicted landmarks, depicted groups of one or more individuals, other depicted entities, e.g., animals, pets, flowers, cars, etc.

Thus, for example, an image share rule can be a rule that identifies an individual Jack with flowers such that each captured image that depicts one or more flowers will be associated with Jack and ultimately sent to the com addresses affiliated with Jack in the entity information. As another example, an image share rule can be a rule that identifies an individual Sue with images captured in the state of Washington such that each captured image that is taken in Washington will be associated with Sue and ultimately sent to the com addresses affiliated with Sue in the entity information.

In an embodiment, if at decision block 102 it is determined that the user does wish to obtain, or otherwise upload, existing entity information to their mobile camera device then the identified existing entity information is retrieved, or otherwise uploaded, and stored on the user's mobile camera device 104.

In an embodiment at decision block 106 a determination is made as to whether the user wishes to generate entity information, i.e., generate one or more contacts that each identifies one or more individuals with one or more com addresses and/or generate one or more image share rules that each identifies one or more individuals and/or com addresses for individuals with one or more image characteristics. If yes, in an embodiment the user inputted entity information is received and stored on the user's mobile camera device 108.

In embodiments user generated entity information can be input to the user's mobile camera device utilizing one or more input instrumentations. Examples of input instrumentations include, but are not limited to, a keypad a user types on to generate and input entity information into the user's mobile camera device, a touch screen a user utilizes to generate and input entity information into the user's mobile camera device, voice activation components a user speaks into for generating and inputting entity information into the user's mobile camera device, etc.

In an embodiment at decision block 110 a determination is made as to whether the user wishes to upload images and/or captured image features to the user's mobile camera device. In an embodiment a user may wish to upload images and/or captured image features for use in identifying individuals, depicted locations, landmarks and other entities and objects in future images captured on the user's mobile camera device. For example, uploaded images or captured image features can be utilized with face recognition technology to identify individuals in future captured images on the user's mobile camera device.

In an embodiment, if at decision block 110 it is determined that the user does wish to obtain, or otherwise upload, existing images and/or captured image features to their mobile camera device then the identified existing images and/or captured image features are retrieved, or otherwise uploaded, and stored on the user's mobile camera device 112. In an embodiment any tags associated with an uploaded image and uploaded captured image feature are also uploaded and stored on the user's mobile camera device 112.

In an embodiment at decision block 114 a determination is made as to whether the user has captured an image, e.g., taken a picture, with their mobile camera device. If no, in an embodiment the logic returns to decision block 102 where a determination is made as to whether the user wishes to obtain existing entity information.

If at decision block 114 the user has captured an image with their mobile camera device then in an embodiment a timestamp is generated and saved as entity information and/or a tag for the captured image 116. In an embodiment GPS, global positioning system, instruments and applications are utilized to derive timestamps for a captured image 116. In alternative embodiments timestamps are generated by the mobile camera device utilizing other devices and/or systems 116, e.g., a mobile camera device clock, cell phone transmission towers, etc.

Referring to FIG. 1B, in an embodiment at decision block 118 a determination is made as to whether there is current GPS location information available for the captured image; i.e., a determination is made as to whether the mobile camera device supports GPS location gathering information for captured images, e.g., latitude, longitude, etc., and was successful in deriving reliable GPS location information for the captured image. If yes, in an embodiment the GPS location information for the captured image is stored as entity information and/or a tag for the captured image 120.

In an embodiment at decision block 122 a determination is made as to whether there are one or more persons depicted in the captured image. In an embodiment face detection, recognition, technology is utilized to determine whether there are one or more persons depicted in the captured image 122. If yes, in an embodiment face recognition technology, i.e., one or more applications capable of processing face recognition calculations, is executed to attempt to generate a best guess for the identity of each individual depicted in the captured image 124.

In an alternative embodiment, if at decision block 122 it is determined that there are one or more persons depicted in the captured image then face recognition technology is executed to attempt to generate two or more best guesses, i.e., a best guess pool, for the identify of each individual depicted in the captured image 124. In an aspect of this alternative embodiment a best guess pool of two or more best guesses for an image-captured individual consists of a maximum predefined number, e.g., two, three, etc., of the most favorable prospective best guess identifications for the image-captured individual.

In an embodiment the face recognition technology utilized to generate a best guess, or, alternatively, best guess pool, for each depicted individual utilizes stored images and/or identifications of face features discerned there from, to compare faces, or face features, identified in prior images with the faces, or face features, of the individuals in the current captured image.

In an embodiment the face recognition technology utilizes prior captured images and/or identifications of face features previously discerned there from stored on the user's mobile camera device or otherwise directly accessible by the mobile camera device, e.g., via a plug-in storage drive, etc., collectively referred to herein as stored on the user's mobile camera device, to attempt to generate a best guess, or, alternatively, a best guess pool, for the identity of each individual in the captured image 124. In an alternative embodiment images and/or face feature identifications previously discerned there from stored other than on the user's mobile camera device, e.g., on a website hosted by a server, on the user's desktop computer, etc., are accessed via wireless communication by the user's mobile camera device and are utilized by the face recognition technology to attempt to generate a best guess, or, alternatively, a best guess pool, for the identity of each individual in the captured image 124. In a second alternative embodiment images and/or face feature identifications previously discerned there from stored on the user's mobile camera device and images and/or face feature identifications previously discerned there from stored elsewhere and accessed via wireless communication by the mobile camera device are utilized by the face recognition technology to attempt to generate a best guess, or, alternatively, a best guess pool, for the identity of each individual in the captured image 124.

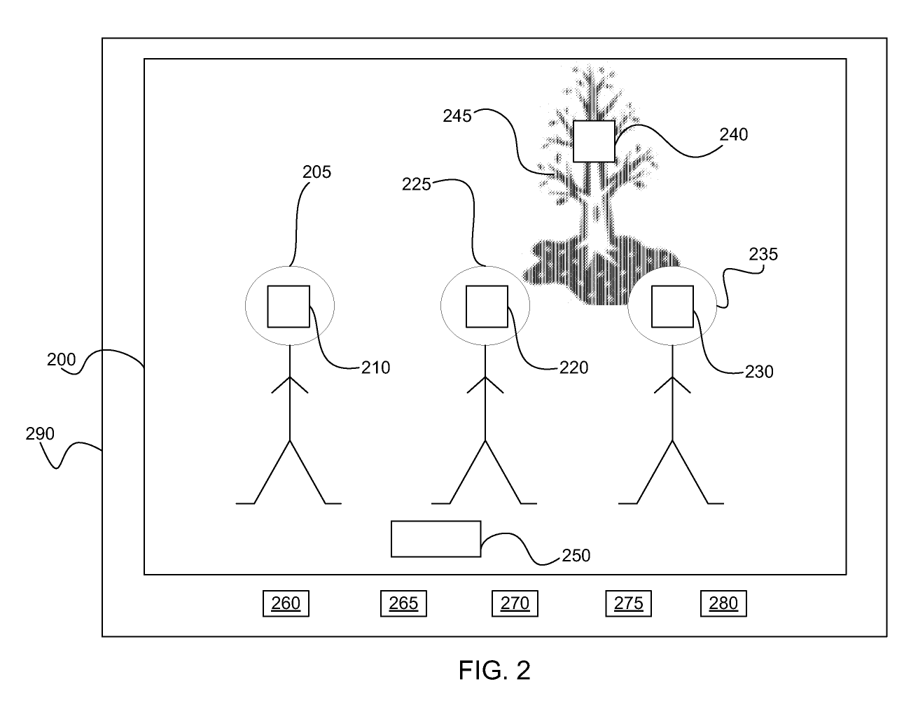

In an embodiment each generated best-guess for the identity of an individual depicted in the captured image is associated with, i.e., exhibited or output with, the respective displayed person in the photo 126. For example, and referring to FIG. 2, three individuals, person A 205, person B 225 and person C 235, are photographed in an exemplary captured image 200 output to a user on a mobile camera device display 290. In an embodiment face recognition technology is utilized to attempt to generate a best guess, or, alternatively, a best guess pool of best guesses, for each depicted individual in the captured image 200 wherein each generated best guess is a determination of a depicted individual. In an embodiment and the example of FIG. 2 a best guess identification is generated for person A 205, a best guess identification is generated for person B 225, and a best guess identification is generated for person C 235. In an alternative embodiment and the example of FIG. 2 a best guess pool of two or more best guess identifications is generated for person A 205, a best guess pool of two or more best guess identifications is generated for person B 225, and a best guess pool of two or more best guess identifications is generated for person C 235.

In an embodiment and the example of FIG. 2 the generated best guess, or best guess pool, 210 for the identity of person A 205 is associated, i.e., output, with person A 205 displayed in the captured image 200 output to a user on the mobile camera device display 290. For example, assume a best guess of Joe is generated for person A 205. In an embodiment and the example of FIG. 2, “Joe” 210 is associated and displayed with the image of person A 205 in the captured image 200 output on the mobile camera device display 290. In an aspect of this embodiment and example “Joe” 210 is written over the depicted face of person A 205 in the captured image 200 output on the mobile camera device display 290. In other aspects of this embodiment the best guess is output in the captured image 200 in other image positions, e.g., across the individual's body, above the individual's head, below the individual's feet, etc.

In an embodiment and the example of FIG. 2 the generated best guess, or best guess pool, 220 for the identity of person B 225 is associated with person B 225 displayed in the captured image 200. For example, assume a best guess of Sue is generated for person B 225. In an embodiment and the example of FIG. 2, “Sue” 220 is associated and displayed with the image of person B 225 in the captured image 200 output on the mobile camera device display 290. As a second example, assume a best guess pool of Sue, Amy and Ruth is generated for person B 225. In an embodiment and the example of FIG. 2, “Sue”, “Amy” and “Ruth” 220 are associated and displayed with the image of person B 225 output on the mobile camera device display 290.

In an embodiment and the example of FIG. 2 the generated best guess 230 for the identity of person C 235 is associated with person C 235 displayed in the captured image 200. For example, assume a best guess of Ann is generated for person C 235. In an embodiment and the example of FIG. 2, “Ann” 230 is associated and displayed with the image of person C 235 output on the mobile camera device display 290.

In an embodiment if no best guess can be generated for an individual depicted in a captured image then nothing is overlaid or otherwise associated with the displayed image of the person. Thus, for example in FIG. 2 if no best guess can be generated for person C 235 then the display of person C 235 output on the mobile camera device display 290 remains simply the image of person C 235.

In alternative embodiments if no best guess can be generated for an individual depicted in a captured image then an indication of such is overlaid or otherwise associated with the displayed image of the person. Thus, for example in FIG. 2 in an alternative embodiment if no best guess can be generated for person C 235 then an indication of such, e.g., a question mark (“?”), etc., is associated and displayed with the image of person C 235 output on the mobile camera device display 290. In an aspect of these alternative embodiments and example a question mark (“?”) is written over the depicted face of person C 235 in the captured image 200 output on the mobile camera device display 290. In other aspects of these alternative embodiments the indication that no best guess could be generated for an individual is output in the captured image 200 in other image positions, e.g., across the individual's body, above the individual's head, below the individual's feet, etc.

Referring again to FIG. 1B, in an embodiment at decision block 128 a determination is made as to whether the user has confirmed the identity of a person depicted in the captured image. In an embodiment a user confirms the identity of a depicted person by touching the best guess identification associated and displayed with the depiction of the person in the captured image. For example, and referring to FIG. 2, in this embodiment a user confirms the identity of person A 205 as “Joe” by touching “Joe” 210 associated and displayed with person A 205 in the captured image 200.

In an embodiment a user confirms the identity of a depicted person by selecting a best guess in the best guess pool associated and displayed with the depiction of the person in the captured image. For example, and again referring to FIG. 2, in this embodiment a user confirms the identity of person B 225 as “Ruth” by choosing and touching “Ruth” 220 associated and displayed with person B 225 in the captured image 200.

In other embodiments a user confirms the identity of a depicted person for which at least one best guess has been generated by various other input mechanisms, e.g., selecting a best guess and pressing a confirm button 260 displayed on a touch screen associated with the mobile camera device, selecting a best guess and typing a predefined key on the mobile camera device keypad, etc.

If at decision block 128 the user has confirmed a best guess identification of an individual depicted in the captured image then in an embodiment the best guess identification is stored as a tag for the captured image 130. In an embodiment, any relevant tag information stored with prior images and/or captured image features depicting the confirmed individual is also stored as a tag for the captured image 130.

In an embodiment, if at decision block 128 the user alternatively has indicated the best guess, or best guess pool, i.e., all displayed best guesses, is incorrect, at decision block 132 a determination is made as to whether there is user input for the individual depicted in the captured image. For example, and again referring to FIG. 2, the user may indicate that the best guess “Joe” 210 for person A 205 is incorrect, e.g., by selecting a touch screen error button 270 on the mobile camera device display 290 while the individual for whom the best guess, or best guess pool, is in error is chosen, e.g., by a user first having selected the displayed image of this person, etc. The user may thereafter input the correct identification for person A 205, e.g., “Sam”, by, e.g., typing in the person's name using a keypad or touch screen associated with the mobile camera device, selecting a contact that correctly identifies person A 205 from stored entity information, etc.

Referring back to FIG. 1B, if at decision block 132 there is user input for a depicted individual that the user does not accept a generated best guess for then in an embodiment the user input is stored as a tag for the captured image 134. In an embodiment user input identifying a depicted individual is associated with, or otherwise exhibited or output with, the respective displayed person in the captured image on the mobile camera device display 134.

In an embodiment, whether the user has confirmed a best guess identification for an individual depicted in the captured image or indicated the best guess, or best guess pool, is incorrect and supplied a correct identification, a search is made on the entity information for any com addresses associated with the confirmed identity for the individual 136. In an embodiment at decision block 138 a determination is made as to whether there are any com addresses associated with the confirmed individual in the stored entity information. If yes, in an embodiment the captured image is automatically transmitted to each com address associated with the confirmed individual in the entity information 140.

Referring to FIG. 1C, in an embodiment at decision block 142 a determination is made as to whether there are any more individuals in the captured image with best guesses, or best guess pools, that the user has not yet confirmed or otherwise acted upon, i.e., indicated as being in error. If yes, in an embodiment the logic flow returns to decision block 128 of FIG. 1B where a determination is again made as to whether the user has confirmed a best guess identification of an individual depicted in the captured image.

If at decision block 142 of FIG. 1C there are no more individuals depicted in the captured image with generated best guess identifications then in an embodiment at decision block 144 a determination is made as to whether there are any more individuals without best guesses depicted in the captured image. If yes, in an embodiment at decision block 146 a determination is made as to whether there is user input for an individual depicted in the captured image for which no best guess identification was generated. For example, and again referring to FIG. 2, assume no best guess identification could be generated for person C 235 but the user has identified person C 235 as “Ann,” by, e.g., typing “Ann” on a keypad or touch screen of the mobile camera device, selecting “Ann” from stored entity information, etc.

Referring back to FIG. 1C, if there is user input for an individual depicted in the captured image then in an embodiment the user input is stored as a tag for the captured image 148. In the current example, the identification of “Ann” supplied by the user is stored as a tag for the captured image 200. In an embodiment user input identifying a depicted individual is associated with, or otherwise exhibited or output with, the respective displayed person in the captured image on the mobile camera device display 148.

In an embodiment a search is made on the entity info for com addresses associated with the confirmed identity for the individual depicted in the captured image 150. In an embodiment at decision block 152 a determination is made as to whether there are any com addresses associated with the confirmed individual in the stored entity information. If yes, in an embodiment the captured image is automatically transmitted to each com address associated with the confirmed individual in the entity information 154.

In an embodiment, whether or not there are any com addresses for outputting the captured image to at decision block 152, at decision block 144 a determination is once again made as to whether or not there are any more individuals depicted in the captured image for which there is no best guess or confirmed identity for.

In an embodiment, if at decision block 144 there are no more depicted individuals in the captured image for which there is no best guess or confirmed identity for or at decision block 146 there is no user input for an individual depicted in the captured image then, referring to FIG. 1D, scene identification technology, i.e., one or more applications capable of processing scene image calculations, is executed to attempt to identify additional information about the captured image 156. Such additional information, referred to herein as scene information, or elements or components, can include, but is not limited to, or can be a subset of, the photographic capture location, i.e., where the photograph was taken, any captured landmarks, e.g., Mount Rushmore, the Eiffel Tower, etc., other depicted entities or objects, e.g., the family dog “Rex”, flowers, a car, etc., etc.

In an embodiment scene identification technology is utilized to attempt to generate a best guess for the identity of one or more scene elements, or components, depicted in a captured image 156. In an alternative embodiment, scene identification technology is utilized to attempt to generate two or more best guesses, i.e., a best guess pool, for the identify of one or more scene elements, or components, depicted in the captured image 156. In an aspect of this alternative embodiment a best guess pool of two or more best guesses for an image-captured scene element consists of a maximum predefined number, e.g., two, three, etc., of the most favorable prospective best guess identifications for the image-captured scene element.

In an embodiment the scene identification technology utilized to generate a best guess, or, alternatively, a best guess pool, for one or more scene elements utilizes stored images and/or identifications of scene elements or scene element features and/or classifiers, to compare scene information, or scene element features and/or classifiers, identified in prior images with the scene and objects and entities captured in the current image 156.

In an embodiment the scene identification technology utilizes prior captured images and/or scene element features and/or classifiers stored on the user's mobile camera device or otherwise directly accessible by the mobile camera device, e.g., via a plug-in storage drive, etc., collectively referred to herein as stored on the user's mobile camera device, to attempt to generate a best guess, or, alternative a best guess pool, for one or more scene elements in the captured image 156. In an alternative embodiment images and/or scene element features and/or classifiers stored other than on the user's mobile camera device, e.g., on a website hosted by a server, on the user's desktop computer, etc., are accessed via wireless communication by the user's mobile camera device and are utilized by the scene identification technology to attempt to generate a best guess, or, alternatively, a best guess pool, for one or more scene elements in the captured image 156. In a second alternative embodiment images and/or scene element features and/or classifiers stored on the user's mobile camera device and images and/or scene element features and/or classifiers stored elsewhere and accessed via wireless communication by the mobile camera device are utilized

In an embodiment each generated best-guess for a scene element, i.e., the scene and/or one or more entities or objects depicted in the captured image is associated with the respective scene or entity or object in the displayed image 158. For example, and referring to FIG. 2, in an embodiment scene identification technology is utilized to generate a best guess identification, or best guess scene determinator, of the scene location and the depicted tree 245 in the captured image 200.

In an embodiment and the example of FIG. 2 the generated best guess 250 for the scene location is associated and displayed with the captured image 200. For example, assume a best guess of “Redmond, Wash.” 250 is generated for the captured image scene 200. In an embodiment and the example of FIG. 2, “Redmond, Wash.” 250 is associated and displayed within the captured image 200 output on the mobile camera device display 290. In an aspect of this embodiment and example “Redmond, Wash.” 250 is written in, or otherwise overlaid upon, the captured image 200 output on the mobile camera device display 290.

In an embodiment and the example of FIG. 2 the generated best guess 240 for the depicted tree 245 is associated with the tree 245 displayed in the captured image 200. For example, assume a best guess of “tree” 240 is generated for the depicted tree 245. In an embodiment and the example of FIG. 2, “tree” 240 is associated and displayed with the image of the tree 245 in the captured image 200 output on the mobile camera device display 290.

Referring again to FIG. 1D, in an embodiment at decision block 160 a determination is made as to whether the user has confirmed the identity of the scene and/or depicted entities and/or objects in the captured image for which one or more best guesses has been generated. In an embodiment a user confirms the identity of the depicted scene or an entity or object by touching a best guess identification associated and displayed with scene, entity or object in the captured image. For example, and referring to FIG. 2, in this embodiment a user confirms the depicted scene identity as “Redmond, Wash.” by touching “Redmond, Wash.” 250 associated and displayed within the captured image 200 output on the mobile camera device display 290.

In other embodiments a user confirms the identity of the depicted scene, entities and objects portrayed therein for which at least one best guess has been generated by various other input mechanisms, e.g., selecting a best guess and pressing a touch screen confirm button 260 on the mobile camera device display 290, selecting a best guess and typing a predefined key on the mobile camera device keypad, etc.

If at decision block 160 the user has confirmed a best guess identification of scene information then in an embodiment the best guess identification is stored as a tag for the captured image 162. In an embodiment any relevant tag information stored with prior images, scene element features and/or classifiers depicting the confirmed scene information is also stored as a tag for the captured image 162.

If at decision block 160 the user alternatively indicates a best guess, or all best guesses in a best guess pool, for scene information is incorrect, in an embodiment at decision block 164 a determination is made as to whether there is user input for the scene or portrayed entity or object of the captured image. For example, and again referring to FIG. 2, the user may indicate that the best guess of “Redmond, Wash.” 250 for the captured image scene is incorrect, e.g., by selecting a touch screen error button 270 on the mobile camera device display 290 while the captured scene best guess identification(s) 250 that is (are) in error is (are) selected, e.g., by the user first having selected the best guess identification(s) displayed on the captured image output to the user, etc. The user may thereafter input the correct scene identification for the captured image, e.g., “Sammamish, Wash.”, by, e.g., typing this identification in using a keypad or touch screen associated with the mobile camera device, selecting the correct scene identification from a list stored in the entity information and accessible by the user, etc.

Referring back to FIG. 1D, if at decision block 164 there is user input for scene information depicted in the captured image for which the user does not accept any generated best guesses for then in an embodiment the user input is stored as a tag for the captured image 166.

In an embodiment, whether the user has confirmed a best guess identification for scene information or indicated the best guess, or best guess pool, is incorrect and supplied a correct identification, a search is made on the entity information for any com addresses associated with the confirmed identity for the scene information 168. In an embodiment at decision block 170 a determination is made as to whether there are any com addresses associated with the confirmed scene information in the stored entity information. If yes, in an embodiment the captured image is automatically transmitted to each com address associated with the confirmed scene information in the entity information 172.

In an embodiment at decision block 174 a determination is made as to whether there are any more best guesses for scene information that the user has not yet confirmed, or, alternatively, has indicated are erroneous. If yes, in an embodiment the logic flow returns to decision block 160 where a determination is again made as to whether the user has confirmed the best guess identification of scene information.

If at decision block 174 there are no more best guesses for scene information that have not yet been confirmed or corrected by the user then in an embodiment the logic flow returns to decision block 102 of FIG. 1A where a determination is again made as to whether the user wishes to obtain existing entity information.

In an embodiment a user can simultaneously confirm all best guesses generated for individuals depicted in a captured image. In an aspect of this embodiment, if a user determines that each best guess generated for an individual in a captured image is correct the user can select a touch screen confirm all button 265 on the mobile camera device display 290 and each generated best guess for a displayed individual will be confirmed and processed as discussed in embodiments above. In other aspects of this embodiment, if a user determines that each best guess generated for an individual in a captured image is correct the user can confirm all these best guesses simultaneously utilizing other input mechanisms, e.g., typing a predefined key on the mobile camera device keypad, etc.

In an embodiment a user can simultaneously confirm all best guesses generated for scene elements depicted in a captured image. In an aspect of this embodiment, if a user determines that each best guess generated for a scene element in a captured image is correct the user can select a touch screen confirm all button 265 on the mobile camera device display 290 and each generated best guess for a displayed scene element will be confirmed and processed as discussed in embodiments above. In other aspects of this embodiment, if a user determines that each best guess generated for a scene element in a captured image is correct the user can confirm all these best guesses simultaneously utilizing other input mechanisms, e.g., typing a predefined key on the mobile camera device keypad, etc.

In an embodiment a user can simultaneously identify all best guesses generated for individuals depicted in a captured image as being incorrect. In an aspect of this embodiment, if a user determines that each best guess generated for an individual in a captured image is incorrect the user can select a touch screen all error button 275 on the mobile camera device display 290 and each generated best guess for a displayed individual will be processed as being erroneous in accordance with embodiments discussed above. In other aspects of this embodiment, if a user determines that each best guess generated for an individual in a captured image is incorrect the user can identify all these best guesses as being erroneous simultaneously utilizing other input mechanisms, e.g., typing a predefined key on the mobile camera device keypad, etc.

In an embodiment a user can simultaneously identify all best guesses generated for scene elements depicted in a captured image as being incorrect. In an aspect of this embodiment, if a user determines that each best guess generated for a scene element in a captured image is incorrect the user can select a touch screen all error button 275 on the mobile camera device display 290 and each generated best guess for a displayed scene element will be processed as being erroneous in accordance with embodiments discussed above. In other aspects of this embodiment, if a user determines that each best guess generated for a scene element in a captured image is incorrect the user can identify all these best guesses as being erroneous simultaneously utilizing other input mechanisms, e.g., typing a predefined key on the mobile camera device keypad, etc.

In an alternative embodiment a user proactively confirms that a captured image is to be transmitted to one or more com addresses once one or more individuals and/or one or more scene elements depicted therein are correctly identified and associated with one or more com addresses. In this alternative embodiment the user indicates that a best guess for an individual or scene element is correct by, e.g., selecting a confirm button 260, etc., while the individual or scene element is selected, etc. In this alternative embodiment the user thereafter confirms that the captured image is to be transmitted to associated com addresses by, e.g., selecting the confirm button 260 a second time, selecting a second, transmit, button 280 on the mobile camera device display 290, typing a predefined key on the mobile camera device keypad, etc.

In an aspect of this alternative embodiment the user can select one or more com addresses associated with an identified individual or scene element in a captured image that the image should be sent to, or, alternatively should not be sent to, by, e.g., selecting the one or more com addresses from a list output to the user, etc. In this aspect of this alternative embodiment the captured image will thereafter be transmitted automatically to the com addresses the user has selected for transmittal, or alternatively, the captured image will not be transmitted to those com addresses the user has indicated should not be used for forwarding the captured image to.

As previously noted, in an embodiment the logic flow of FIGS. 1A-1D is processed on a user's mobile camera device. In other embodiments subsets of the steps of the logic flow of FIGS. 1A-1D is processed on another device, e.g., in a cloud hosted on a server or other computing device distinct from the user's mobile camera device. For example, in one alternative embodiment the user's mobile camera device transmits a captured image and/or features depicted therein to a cloud which executes the face recognition and image scene identification technologies on the captured image and/or depicted features. In this alternative embodiment the cloud transmits the results thereof back to the user's mobile camera device for any further user interaction, e.g., user confirmation of any generated best guesses.

Referring to FIG. 3, an embodiment image share application, or image share app, 300 processes images captured on a user's mobile camera device 350 for transmittal to other users and/or devices. In an embodiment the image share app 300 is hosted and executes on the user's mobile camera device 350.

In an embodiment an upload image procedure 315 of the image share app 300 manages the uploading of prior captured images 345 and any associated tags 340 currently stored on devices other than the user's mobile camera device 350, e.g., currently stored on a hard-drive, the user's desktop computer, a USB stick drive, etc. In an embodiment the upload image procedure 315 analyzes the tags 340 associated with each uploaded image 345 and stores the uploaded images 355 and their associated tags 340 in an image database 320. In an embodiment the image database 320 is hosted on the user's mobile camera device 350. In other embodiments the image database 320 is hosted on other storage devices, e.g., a USB stick drive, that is communicatively accessible to the user's mobile camera device 350. In an embodiment associated tags 340 are included within the file containing the captured image 345.

In embodiments the upload image procedure 315 also, or alternatively, manages the uploading of image features 345, e.g., facial features, image objects and/or elements, e.g., tree, mountain, car, etc., and/or image object and/or element features, e.g., leaf on a tree, wheel on a car, etc., etc., extracted from prior captured images 345 and any associated tags 340. In an embodiment uploaded image features 355 and any associated tags 340 are stored in the image database 320. In an embodiment associated tags 340 are included within the file containing the captured features, objects and/or elements 345. In an embodiment uploaded features 345 are used by the face recognition technology and scene identification technology of the image share app 300 to generate best guesses for captured image individuals and elements.

In an embodiment the upload image procedure 315 of the image share app 300 generates, populates, modifies and accesses the image database 320, and thus for purposes of description herein the image database 320 is shown as a component of the image share app 300.

In an embodiment a user 370 can initiate the uploading of existing entity information 330, e.g., contact lists, address books, image share rules, etc., to the user's mobile camera device 350. In an embodiment a user 370 can also, or alternatively, input entity information 330 to the user's mobile camera device 350 using, e.g., a keypad, touch screen, voice activation, etc. In an embodiment an entity info procedure 305 of the image share app 300 manages the uploading of existing entity information 330 and the inputting of user-generated entity information 330 to the user's mobile camera device 350.

In an embodiment the entity info procedure 305 analyzes the received entity information 330 and stores the entity information 380, or entity information derived there from 380, in an entity info database 310. In an embodiment the entity info database 310 is hosted on the user's mobile camera device 350. In other embodiments the entity info database 310 is hosted on other storage devices, e.g., a USB stick drive, that is communicatively accessible to the user's mobile camera device 350.

In an embodiment the entity info procedure 305 generates, populates, modifies and accesses the entity info database 310, and thus for purposes of description herein the entity info database 310 is shown as a component of the image share app 300.

In an embodiment a user 370 utilizes their mobile camera device 350, which includes a camera, to capture an image 335, e.g., take a picture. In an embodiment the captured image 335 is processed by an image procedure 325 of the image share app 300. In an embodiment the image procedure 325 analyzes a captured image 335 in conjunction with one or more other images 355 stored in the image database 320 and/or one or more stored features 355 extracted from prior captured images 345 to attempt to generate a best guess, or, alternatively, a best guess pool, for one or more persons depicted in the captured image 335. In an embodiment the image procedure 325 analyzes the captured image 335 in conjunction with one or more other images 355 stored in the image database 320 and/or one or more stored features and/or classifiers 355 extracted from prior captured images 345 to attempt to generate a best guess, or, alternatively, a best guess pool, for one or more scene elements, e.g., the image scene location, any image landmarks, and/or one or more image entities or objects, e.g., flowers, cars, buildings, etc.

In an embodiment the image procedure 325 utilizes information from stored tags 355 in generating best guesses for captured image individuals and scene elements.

In an embodiment the image procedure 325 overlays its best guesses on the respective individuals or scene elements in the captured image 335 as depicted in and described with regards to the example of FIG. 2, and the result is output to the user 370 on the mobile camera device display 290 for confirmation and/or user input. In an embodiment when the image share app 300 receives a user confirmation 375 for an image share app generated best guess the image procedure 325 accesses the entity info database 310 to determine if there are any com addresses associated with the confirmed individual or scene element. If yes, in an embodiment the image procedure 325 automatically transmits the captured image 335 to the com addresses associated with the confirmed individual or scene element via one or more communication networks 365, e.g., the internet, one or more SMS-based networks, one or more telephone system networks, etc. In an aspect of this embodiment the image procedure 325 wirelessly transmits the captured image 335 to the respective com addresses via their associated communication network(s) 365.

In an embodiment when the image share app 300 receives user input 385 identifying a captured image individual or scene element the image procedure 325 accesses the entity info database 310 to determine if there are any com addresses associated with the user-identified individual or scene element. If yes, in an embodiment the image procedure 325 automatically transmits the captured image 335 to the com addresses associated with the user-identified individual or scene element via one or more communication networks 365. In an aspect of this embodiment the image procedure 325 wirelessly transmits the captured image 335 to the respective com addresses via their associated communication network(s) 365.

In an alternative embodiment, if there exists com addresses associated with a user-confirmed best guess or user-identified individual or scene element of a captured image 335 the user 370 then explicitly commands the mobile camera device 350 to transmit the captured image 335 to one or more of the associated com addresses by, e.g., selecting a touch screen confirm button 260 on the mobile camera device display 290 a second time, selecting a touch screen transmit button 280 on the mobile camera device display 290, typing a predefined key on a keypad associated with the mobile camera device 350, etc.

In an embodiment generated best guess information, e.g., individual identities, image capture locations, landmark identifications, etc., that are confirmed 375 by the user 370 are used to generate one or more tags for the captured image 335. In an embodiment user-generated identifications of captured image individuals and scene elements, e.g., individual identities, image capture locations, landmark identifications, etc., are used to generate one or more tags for the captured image 335. In an embodiment generated tags 355 are stored with, or otherwise associated with, the captured image 355 and/or captured image extracted features 355 stored in the image database 320.

In an embodiment the image procedure 325 procures GPS-generated information relevant to the captured image 335, e.g., reliable location and time information, and utilizes this information in one or more tags that are associated with the captured image 335. In alternative embodiments time information utilized by the image share app 300 for processing and tagging captured images 335 is generated by other devices and/or systems, e.g., a mobile camera device clock, cell phone transmission towers, etc.

In an embodiment the image procedure 325 stores the captured image 335 in the image database 320. In an alternative embodiment the captured image 335 is accessible by the upload image procedure 315 which analyzes any tags generated for the captured image 335 and stores the captured image 335 and its associated tags in the image database 320.

In embodiments captured image extracted features, e.g., facial features, image elements and/or objects and/or image element and/or object features, are also, or alternatively, stored in the image database 320. In an embodiment the image procedure 325 stores the captured image extracted features in the image database 320. In an alternative embodiment features extracted from a captured image 335 are accessible by the upload image procedure 315 which analyzes any tags generated for the captured image 335 and/or its extracted features and stores the extracted features and any image or feature associated tags in the image database 320.

In an alternative embodiment, one or more tasks for processing a captured image 335 and transmitting the captured image 335 to one or more com addresses and/or devices other than the user's mobile camera device 350 are performed in a cloud 360 accessible to the image share app 300 via one or more communications networks 365, e.g., the internet; i.e., are executed via cloud computing. In one aspect of this alternative embodiment the image database 320 is hosted on a remote server from the user's mobile camera device 350. In this aspect of this alternative embodiment, when a user 370 captures an image 335 the image procedure 325 transmits the captured image 335 to the cloud 360. In this aspect of this alternative embodiment the cloud 360 analyzes the captured image 335 with respect to prior captured images 355 and/or features extracted from prior captured images 355 stored in the image database 320 and attempts to generate best guesses for individuals portrayed in and/or scene elements of the captured image 335. In this aspect of this alternative embodiment the cloud 360 transmits its generated best guesses to the image share app 300 which, via the image procedure 325, overlays the best guesses on the respective individuals or scene elements in the captured image 335 as depicted in the example of FIG. 2, and the result is output to the user 370 for confirmation and/or user input.

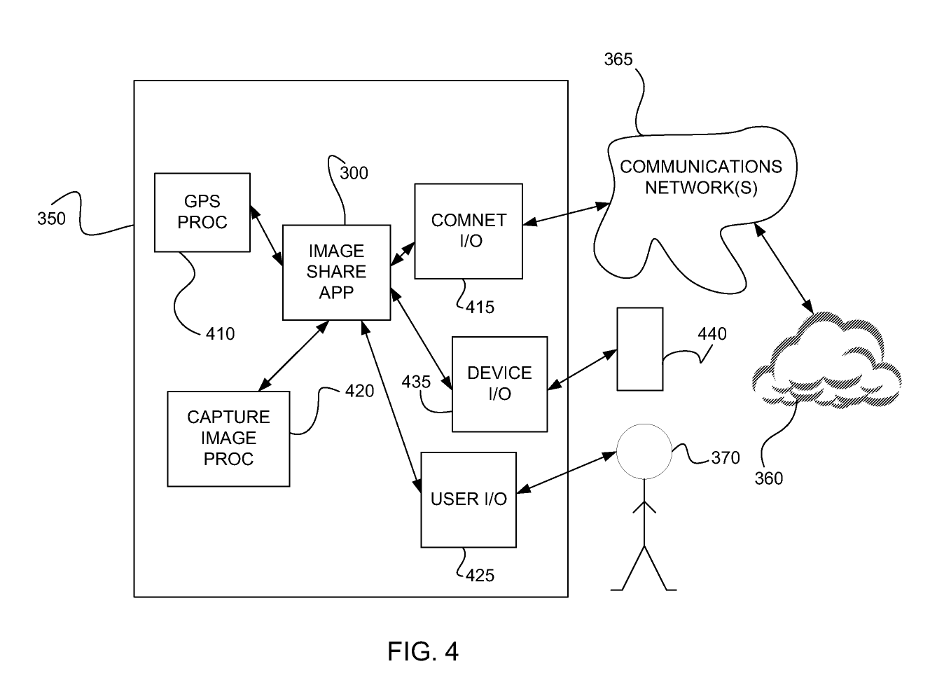

FIG. 4 depicts an embodiment mobile camera device 350 with the capability to capture images, identify recipients of the captured images and share the captured images with the identified recipients. In an embodiment the image share app 300 discussed with reference to FIG. 3 executes on the mobile camera device 350. In an embodiment a capture image procedure 420 executes on the mobile camera device 350 for capturing an image 335 that can then be viewed by the user, photographer, 370, and others, stored, and processed by the image share app 300 for sharing with other individuals and/or devices.

In an embodiment a GPS, global positioning system, procedure 410 executes on the mobile camera device 350 for deriving reliable location and time information relevant to a captured image 335. In an embodiment the GPS procedure 410 communicates with one or more sensors of the mobile camera device 350 that are capable of identifying the current time and one or more aspects of the current location, e.g., longitude, latitude, etc. In an embodiment the GPS procedure 410 derives current GPS information for a captured image 335 which it then makes available to the image share app 300 for use in processing and sharing a captured image 335.

In an embodiment a user I/O, input/output, procedure 425 executes on the mobile camera device 350 for communicating with the user 370. In embodiments the user I/O procedure 425 receives input, e.g., data, commands, etc., from the user 370 via one or more input mechanisms including but not limited to, a keypad, a touch screen, voice activation technology, etc. In embodiments the user I/O procedure 425 outputs images and data, e.g., best guesses, command screens, etc. to the user 370. In an embodiment the user I/O procedure 425 communicates, or otherwise operates in conjunction, with the image share app 300 to provide user input to the image share app 300 and to receive images, images with best guesses overlaid thereon, command screens that are to be output to the user 370 via, e.g., a mobile camera device display 290, etc.

In an embodiment a device I/O procedure 435 executes on the mobile camera device 350 for communicating with other devices 440, e.g., a USB stick drive, etc., for uploading, or importing, previously captured images 345 and/or features 345 extracted from previously captured images 345 and/or prior generated entity information 330. In an embodiment the device I/O procedure 435 can also communicate with other devices 440, e.g., a USB stick drive, etc., for downloading, or exporting, captured images 355 and/or features extracted there from 355, captured image and/or extracted feature tags 355, and/or user-generated entity information 380 for storage thereon. In an embodiment the device I/O procedure 435 communicates, or otherwise operates in conjunction, with the image share app 300 to import or export captured images and/or features extracted there from, import or export captured image and/or extracted feature tags, to import or export entity information, etc.

In an embodiment a communications network I/O procedure, also referred to herein as a comnet I/O procedure, 415 executes on the mobile camera device 350 for communicating with one or more communication networks 365 to, e.g., upload previously captured images 345, to upload features 345 extracted from previously captured images 345, to upload prior generated entity information 330, to transmit a captured image 355 to one or more individuals or other devices, to communicate with a cloud 360 for image processing and sharing purposes, etc. In an embodiment the comnet I/O procedure 415 communicates, or otherwise operates in conjunction, with the image share app 300 to perform wireless communications network input and output operations that support the image share app's processing and sharing of captured images 335.

### COMPUTING DEVICE SYSTEM CONFIGURATION

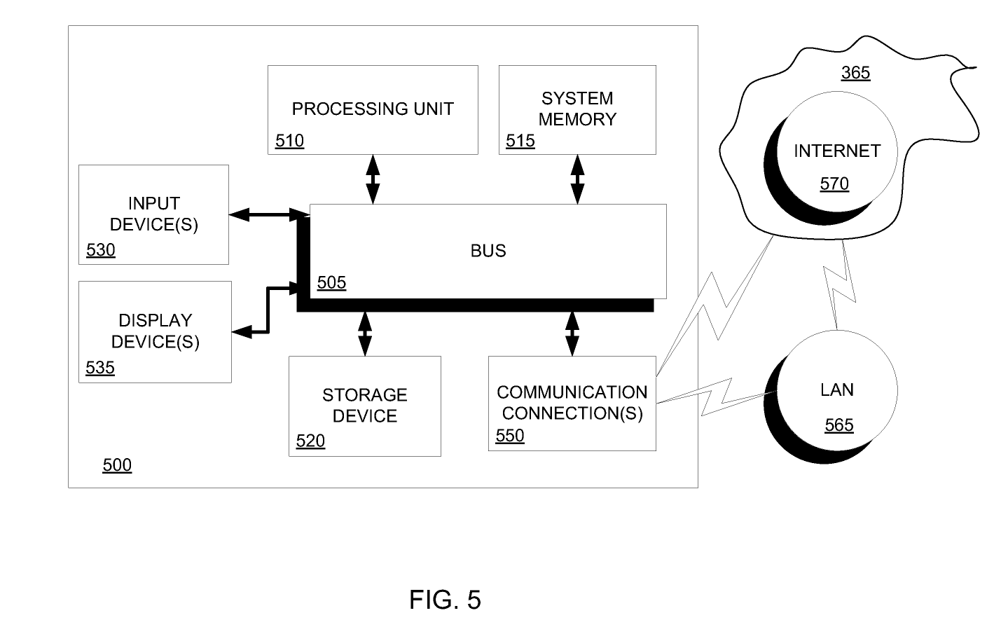

FIG. 5 is a block diagram that illustrates an exemplary computing device system 500 upon which an embodiment can be implemented. Examples of computing device systems, or computing devices, 500 include, but are not limited to, computers, e.g., desktop computers, computer laptops, also referred to herein as laptops, notebooks, etc.; smart phones; camera phones; cameras with internet communication and processing capabilities; etc.

The embodiment computing device system 500 includes a bus 505 or other mechanism for communicating information, and a processing unit 510, also referred to herein as a processor 510, coupled with the bus 505 for processing information. The computing device system 500 also includes system memory 515, which may be volatile or dynamic, such as random access memory (RAM), non-volatile or static, such as read-only memory (ROM) or flash memory, or some combination of the two. The system memory 515 is coupled to the bus 505 for storing information and instructions to be executed by the processing unit 510, and may also be used for storing temporary variables or other intermediate information during the execution of instructions by the processor 510. The system memory 515 often contains an operating system and one or more programs, or applications, and/or software code, and may also include program data.

In an embodiment a storage device 520, such as a magnetic or optical disk, is also coupled to the bus 505 for storing information, including program code of instructions and/or data. In the embodiment computing device system 500 the storage device 520 is computer readable storage, or machine readable storage, 520.

Embodiment computing device systems 500 generally include one or more display devices 535, such as, but not limited to, a display screen, e.g., a cathode ray tube (CRT) or liquid crystal display (LCD), a printer, and one or more speakers, for providing information to a computing device user. Embodiment computing device systems 500 also generally include one or more input devices 530, such as, but not limited to, a keyboard, mouse, trackball, pen, voice input device(s), and touch input devices, which a user can utilize to communicate information and command selections to the processor 510. All of these devices are known in the art and need not be discussed at length here.

The processor 510 executes one or more sequences of one or more programs, or applications, and/or software code instructions contained in the system memory 515. These instructions may be read into the system memory 515 from another computing device-readable medium, including, but not limited to, the storage device 520. In alternative embodiments, hard-wired circuitry may be used in place of or in combination with software instructions. Embodiment computing device system 500 environments are not limited to any specific combination of hardware circuitry and/or software.

The term “computing device-readable medium” as used herein refers to any medium that can participate in providing program, or application, and/or software instructions to the processor 510 for execution. Such a medium may take many forms, including but not limited to, storage media and transmission media. Examples of storage media include, but are not limited to, RAM, ROM, EEPROM, flash memory, CD-ROM, USB stick drives, digital versatile disks (DVD), magnetic cassettes, magnetic tape, magnetic disk storage, or any other magnetic medium, floppy disks, flexible disks, punch cards, paper tape, or any other physical medium with patterns of holes, memory chip, or cartridge. The system memory 515 and storage device 520 of embodiment computing device systems 500 are further examples of storage media. Examples of transmission media include, but are not limited to, wired media such as coaxial cable(s), copper wire and optical fiber, and wireless media such as optic signals, acoustic signals, RF signals and infrared signals.

An embodiment computing device system 500 also includes one or more communication connections 550 coupled to the bus 505. Embodiment communication connection(s) 550 provide a two-way data communication coupling from the computing device system 500 to other computing devices on a local area network (LAN) 565 and/or wide area network (WAN), including the world wide web, or internet, 570 and various other communication networks 365, e.g., SMS-based networks, telephone system networks, etc. Examples of the communication connection(s) 550 include, but are not limited to, an integrated services digital network (ISDN) card, modem, LAN card, and any device capable of sending and receiving electrical, electromagnetic, optical, acoustic, RF or infrared signals.

Communications received by an embodiment computing device system 500 can include program, or application, and/or software instructions and data. Instructions received by the embodiment computing device system 500 may be executed by the processor 510 as they are received, and/or stored in the storage device 520 or other non-volatile storage for later execution.

### CONCLUSION

While various embodiments are described herein, these embodiments have been presented by way of example only and are not intended to limit the scope of the claimed subject matter. Many variations are possible which remain within the scope of the following claims. Such variations are clear after inspection of the specification, drawings and claims herein. Accordingly, the breadth and scope of the claimed subject matter is not to be restricted except as defined with the following claims and their equivalents.

What is claimed is:

1. A method for sending a captured image to a com address, the method comprising:
processing a captured image to generate a best guess identification for an individual portrayed in the captured image;
outputting the captured image to a user;
outputting the generated best guess identification to the user;
receiving a confirmation that the best guess identification accurately designates an individual portrayed in the captured image;
automatically ascertaining a com address for the best guess identification; and
automatically transmitting the captured image to the ascertained com address.

2. The method for sending a captured image to a com address of claim 1 wherein the method is executed on a mobile camera device.

3. The method for sending a captured image to a com address of claim 1, further comprising automatically transmitting the captured image to the ascertained com address upon receiving a confirmation that the best guess identification accurately designates an individual portrayed in the captured image.

4. The method for sending a captured image to a com address of claim 1, further comprising:
receiving input from a user comprising a command to transmit the captured image; and
automatically transmitting the captured image to the ascertained com address upon receiving the input from the user comprising a command to transmit the captured image.

5. The method for sending a captured image to a com address of claim 1, further comprising:
storing information obtained from an electronic address book as entity information in a database; and
accessing stored information in the database to automatically ascertain the com address for the best guess identification.

6. The method for sending a captured image to a com address of claim 1, further comprising:
processing the captured image to attempt to generate a best guess identification for each individual whose face is portrayed in the captured image;
outputting each generated best guess identification to the user;
searching at least one database for at least one com address associated with each best guess identification for which a confirmation is received, wherein each such com address that is located is a located com address; and
automatically transmitting the captured image to each located com address.

7. The method for sending a captured image to a com address of claim 6, further comprising receiving input from the user comprising an identification that all best guess identifications output to the user are confirmed as accurately designating individuals portrayed in the captured image.

8. The method for sending a captured image to a com address of claim 6, further comprising:
receiving individual identity information from a user that comprises the identity of an individual whose face is portrayed in the captured image and for whom a best guess identification is not generated;
searching at least one database for at least one com address associated with the received individual identity information comprising the identity of an individual whose face is portrayed in the captured image, wherein each such com address is an individual's com address; and
automatically transmitting the captured image to at least one of the individual's com addresses.

9. The method for sending a captured image to a com address of claim 8, further comprising automatically transmitting the captured image to each of the individual's com addresses.

10. The method for sending a captured image to a com address of claim 6, further comprising:
processing a captured image to generate a best guess pool comprising at least two best guess identifications for an individual portrayed in the captured image;
outputting the best guess identifications of the best guess pool to the user; and
receiving a confirmation that one best guess identification of the best guess pool accurately designates an individual portrayed in the captured image.

11. The method for automatically sending a captured image to a com address of claim 6, further comprising:
receiving a denial of confirmation from a user for a generated best guess identification, wherein the denial of confirmation comprises an indication that the best guess identification is incorrect;
receiving individual identity information from a user that comprises the identity of the individual for whom the denial of confirmation for a generated best guess identification was received;
outputting the received individual identity information from the user to the user;
searching at least one database for at least one com address associated with the received individual identity information comprising the identity of the individual for whom the denial of confirmation for a generated best guess identification was received, wherein each such com address is the individual's com address; and
automatically transmitting the captured image to at least one of the individual's com addresses.

12. The method for automatically sending a captured image to a com address of claim 1, further comprising:
processing a captured image to generate a best guess scene determinator for a scene element of the captured image;
outputting the best guess scene determinator to the user;
receiving a confirmation that the best guess scene determinator accurately designates a scene element of the captured image;
automatically ascertaining a com address for the best guess scene determinator; and
automatically transmitting the captured image to the ascertained com address for the best guess scene determinator.

13. The method for automatically sending a captured image to a com address of claim 12, further comprising:
processing the captured image to attempt to generate a best guess scene determinator for at least two scene elements of the captured image;
outputting each generated best guess scene determinator overlaid upon the outputted captured image to the user;
receiving a denial of confirmation from a user for a generated best guess scene determinator, wherein the denial of confirmation comprises an indication that the best guess scene determinator is incorrect;
receiving scene element information from a user that comprises an identity of the scene element for which the denial of confirmation for a generated best guess scene determinator was received;
outputting the received scene element information from the user to the user;
searching at least one database for at least one com address associated with the received scene element information comprising an identity of the scene element for which the denial of confirmation for a generated best guess scene determinator was received, wherein each such com address is the scene element's com address; and
automatically transmitting the captured image to at least one of the scene element's com addresses.

14. An image share application for outputting a captured image to at least one com address, the image share application comprising:
a procedure comprising the capability to generate a best guess identification for an individual portrayed in the captured image;
a procedure comprising the capability to display the captured image to a user;
a procedure comprising the capability to display the generated best guess identification to the user;
a procedure comprising the capability to receive a confirmation that the best guess identification correctly designates an individual portrayed in the captured image;
a procedure comprising the capability to automatically locate at least one com address that is associated with the best guess identification of an individual portrayed in the captured image;
a procedure comprising the capability to output the captured image to at least one located com address that is associated with the best guess identification of an individual portrayed in the captured image; and
a procedure comprising the capability to generate at least one tag for the captured image that comprises the best guess identification of an individual portrayed in the captured image;

15. The image share application of claim 14, wherein the image share application executes on a mobile camera device.

16. The image share application of claim 14, further comprising a procedure comprising the capability to automatically output the captured image to at least one located individual's com address upon the procedure comprising the capability to receive a confirmation that the best guess identification correctly designates an individual portrayed in the captured image receiving a confirmation that the best guess identification accurately designates an individual portrayed in the captured image.

17. The image share application of claim 14, wherein the image share application further comprises:
a procedure comprising the capability to attempt to generate a best guess identification for each individual whose face is portrayed in the captured image;
a procedure comprising the capability to display each generated best guess identification to the user;
a procedure comprising the capability to search for at least one internet-based address associated with each best guess identification for which a confirmation is received, wherein each internet-based address that is located for a best guess identification for which a confirmation is received is a located internet-based address; and
a procedure comprising the capability to automatically output the captured image to each located internet-based address.

18. A mobile camera device comprising the capability to capture images and to automatically transmit a captured image to at least one com address, the mobile camera device comprising:
a camera comprising the capability to capture an image;
a procedure comprising the capability to utilize face recognition technology to generate a best guess identification for at least one individual portrayed in a captured image;
a procedure comprising the capability to communicate with a user to display a captured image to the user;
a procedure comprising the capability to communicate with a user to display the generated best guess identification to the user;
a procedure comprising the capability to communicate with a user to receive user input comprising a confirmation of a generated best guess identification;
a procedure comprising the capability to associate a com address with an individual portrayed in a captured image for whom a generated best guess identification is confirmed; and
a procedure comprising the capability to communicate with a communications network to automatically transmit a captured image to a com address associated with an individual portrayed in the captured image for whom a generated best guess identification is confirmed.

19. The mobile camera device of claim 18, further comprising:
a database of stored features extracted from prior-captured images that the procedure comprising the capability to utilize face recognition technology to generate a best guess identification for at least one individual portrayed in the captured image accesses for the generation of the best guess identification; and
a database of contact information comprising an identification of at least two persons and the association of at least one com address for each of the at least two persons that the procedure comprising the capability to associate a com address with an individual portrayed in a captured image for whom a generated best guess identification is confirmed accesses for the association of the com address with the individual portrayed in the captured image.

20. The mobile camera device of claim 18, further comprising:
GPS technology comprising the capability to generate at least one location identifier for a captured image;
a rule stored on the mobile camera device that comprises an identification of a com address that is associated with at least one generated location identifier;
a procedure comprising the capability to utilize the rule to associate the com address associated with the at least one generated location identifier with a captured image; and
a procedure comprising the capability to communicate with the communications network to automatically transmit a captured image to a com address associated with the captured image.
